(19) United States
(12) Patent Application Publication
(10) Pub. No.: US 2017/0096033 A1
(43) Pub. Date: Apr. 6, 2017

(54) PNEUMATIC TIRE

(71) Applicant: TOYO TIRE & RUBBER CO., LTD., Osaka (JP)

(72) Inventor: Jiro Taniguchi, Osaka-shi (JP)

(73) Assignee: TOYO TIRE & RUBBER CO., LTD., Osaka (JP)

(21) Appl. No.: 15/269,299

(22) Filed: Sep. 19, 2016

(30) Foreign Application Priority Data
Oct. 6, 2015 (JP) 2015-198705

(51) Int. Cl. B60C 11/03; B60C 11/12; B60C 11/11

(52) U.S. Cl. CPC B60C 11/0304; B60C 11/0306; B60C 11/0302; B60C 11/11; B60C 11/1236; B60C 11/1259; B60C 2011/0355; B60C 2011/0367

(57) ABSTRACT

A block row includes, an inner shoulder row positioned most inside in a tire width direction in a state where a pneumatic tire is mounted on a vehicle, an outer shoulder row positioned most outside in the tire width direction in a state where the pneumatic tire is mounted on the vehicle, an inner intermediate row disposed adjacently to the outside of the inner shoulder row in the tire width direction, and an outer intermediate row disposed adjacently to the inside of the outer shoulder row in the tire width direction. In the block belonging to the inner intermediate row, a tire circumferential direction length is larger than a tire width direction length. In the block belonging to the outer intermediate row, a tire width direction length is larger than a tire circumferential direction length.

### CROSS-REFERENCE TO RELATED APPLICATION

This application claims priority of Japanese Patent Application No. 2015-198705 filed on Oct. 6, 2015, the contents of which are incorporated herein by reference.

### BACKGROUND OF THE INVENTION

Technical Field

The present invention relates to a pneumatic tire.

Related Art

Pneumatic tires disclosed in JP 2013-189131 A, JP 2010-76561 A, JP 2004-155416 A and JP 2010-254092 A respectively have a plurality of block rows extending in a tire circumferential direction. Each block row includes a plurality of blocks arranged in a row in the tire circumferential direction. However, it is not always the case with these conventional pneumatic tires that the pneumatic tire has succeeded in enhancing all of drive performance, braking performance and turning performance.

### SUMMARY

It is an object of the present invention to provide a pneumatic tire which can enhance drive performance, braking performance and turning performance.

An aspect of the present invention provides a pneumatic tire comprising: at least three main grooves formed on a tread portion such that the three main grooves extend in a tire circumferential direction; a plurality of lateral grooves formed on the tread portion; and at least four block rows each of which includes a plurality of blocks defined respectively by the main grooves and the pair of lateral grooves disposed adjacently to each other and arranged in a row in a tire circumferential direction, wherein the block row includes: an inner shoulder row positioned most inside in a tire width direction in a state where the pneumatic tire is mounted on a vehicle; an outer shoulder row positioned most outside in the tire width direction in a state where the pneumatic tire is mounted on the vehicle; an inner intermediate row disposed adjacently to the outside of the inner shoulder row in the tire width direction; and an outer intermediate row disposed adjacently to the inside of the outer shoulder row in the tire width direction, and wherein, in the block belonging to the inner intermediate row, a tire circumferential direction length is larger than a tire width direction length, and wherein, in the block belonging to the outer intermediate row, a tire width direction length is larger than a tire circumferential direction length.

In the block belonging to the inner intermediate row, a tire circumferential direction length is larger than a tire width direction length. That is, the block belonging to the inner intermediate row has an elongated shape in the tire circumferential direction. A camber angle is imparted to a pneumatic tire mounted on a vehicle (hereinafter, referred to as “tire”). Accordingly, there is a tendency that a shape of a ground contact region on a road surface extends in a tire circumferential direction on an inner portion of a tread portion in a tire width direction (particularly, at the time of applying braking). Accordingly, by forming the block belonging to the inner intermediate row into an elongated shape in the tire circumferential direction, drive performance and braking performance on a dry road surface can be enhanced. Further, by forming the block belonging to the inner intermediate row into an elongated shape in the tire circumferential direction, responsiveness to a steering angle when a handle is steered during traveling is enhanced.

In the block belonging to the outer intermediate row, a tire width direction length is larger than a tire circumferential direction length. That is, the block belonging to the outer intermediate row has an elongated shape in the tire width direction. Accordingly, rigidity of the block belonging to the outer intermediate row against a load in a lateral direction (tire width direction) is increased and hence, turning performance on a dry road surface is enhanced. Further, the block belonging to the outer intermediate row is formed into an elongated shape in the tire width direction and hence, an edge component in a tire width direction is increased in an outer-side region of the tread portion in the tire width direction. As a result, drive performance and braking performance on a snowy road surface are also enhanced.

In the block belonging to the inner intermediate row, it is preferable that the tire circumferential direction length be 1.3 to 1.9 times inclusive as large as the tire width direction length.

In the block belonging to the outer intermediate row, it is preferable that the tire width direction length is 1.1 to 1.5 times inclusive as large as the tire circumferential direction length.

It is preferable that a total number of blocks belonging to the inner shoulder row is larger than a total number of blocks belonging to the outer shoulder row, and that a total number of the blocks belonging to the inner intermediate row is smaller than a total number of blocks belonging to the outer intermediate row

By setting the total number of blocks in the inner shoulder row larger than the total number of blocks in the outer shoulder row, traction generated by a snow column shearing force at an inner-side portion of the tread portion in a tire width direction is particularly increased and hence, snow performance is enhanced. Further, setting the total number of blocks in the inner shoulder row larger than the total number of blocks in the outer shoulder row means that the block in the outer shoulder row is relatively larger than the block in the inner shoulder row in size. Accordingly, rigidity of the block in the outer shoulder row against a load in a lateral direction becomes relatively high compared to rigidity of the block in the inner shoulder row against a load in a lateral direction and hence, turning performance on a dry road surface is enhanced.

Setting the total number of blocks in the inner intermediate row smaller than the total number of blocks in the outer intermediate row means that the block in the inner intermediate row has the relatively large tire circumferential direction length compared to the tire circumferential direction length of the block in the outer intermediate row. As described previously, there is a tendency that a shape of a ground contact region of the tire on a road surface extends in a tire circumferential direction at the inner portion of the tread portion in the tire width direction (particularly, at the time of applying braking). Accordingly, by setting the tire circumferential direction length of the block in the inner intermediate row relatively large, drive performance and braking performance on a dry road surface can be enhanced. Further, responsiveness to a steering angle on the dry road surface can be also enhanced.

It is preferable that the block row further includes a center row positioned on a center side of the tread portion in the tire width direction with respect to the inner intermediate row and the outer intermediate row, and that a tire circumferential direction length of the block belonging to the center row is larger than a tire circumferential direction length of the block belonging to any one of the inner shoulder row, the inner intermediate row, the outer intermediate row and the outer shoulder row.

The center row includes a center portion in a tire width direction in the ground contact region with a road surface and hence, by setting the tire circumferential direction length of the block belonging to the center row large, responsiveness to a steering angle can be further enhanced.

The pneumatic tire according to the present invention can enhance drive performance and braking performance and, at the same time, can enhance turning performance.

### BRIEF DESCRIPTION OF THE DRAWINGS

The foregoing and the other features of the present invention will become apparent from the following description and drawings of an illustrative embodiment of the invention in which:

FIG. 1 is a developed view of a tread pattern of a tire according to an embodiment of the present invention;

FIG. 2 is a partial enlarged view of FIG. 1;

FIG. 3 is a schematic cross-sectional view for describing various grooves;

FIG. 4 is a schematic cross-sectional view taken along a line IV-IV in FIG. 2; and

FIG. 5 is a schematic cross-sectional view taken along a line V-V in FIG. 2.

### DETAILED DESCRIPTION OF EMBODIMENTS

An embodiment of the present invention is described with reference to attached drawings.

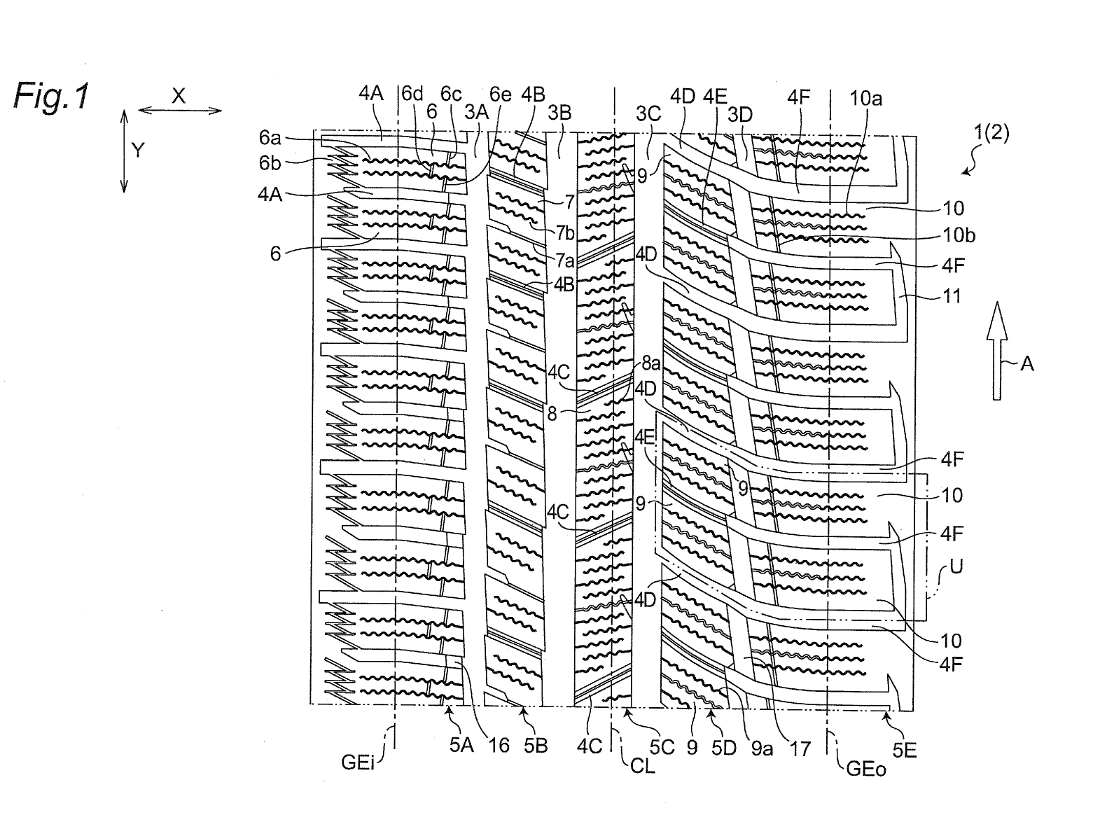

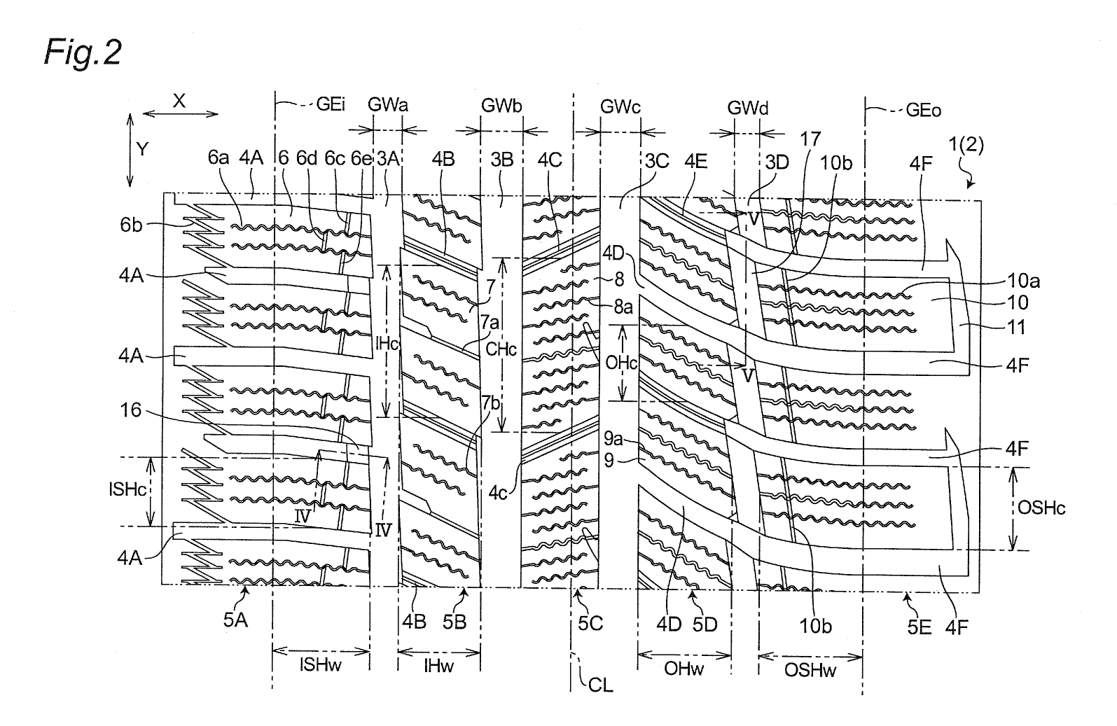

Referring to FIG. 1 and FIG. 2, on a tread portion 2 of a pneumatic tire 1 which is a rubber-made snow tire according to this embodiment (hereinafter, referend to as “tire”), four main grooves 3A to 3D are formed such that the main grooves 3A to 3D extend in a tire circumferential direction (indicated by symbol Y in FIG. 1 and FIG. 2). A plurality of lateral grooves (lug grooves) 4A to 4F are formed on the tread portion 2 such that the lateral grooves 4A to 4F extend in a tire width direction (indicated by symbol X in FIG. 1 and FIG. 2).

A mounting posture of the tire 1 in a tire width direction with respect to a vehicle (not shown in the drawing) is designated. A rotational direction of the tire 1 when the vehicle moves forward is designated as a direction indicated by an arrow A in FIG. 1. In the description made hereinafter, terms “inside” and “outside” in the tire width direction are determined with reference to the case where the tire 1 is mounted on the vehicle in a normal posture. In FIG. 1 and FIG. 2, a center line (equator line) in the tire width direction of the tread portion 2 is indicated by symbol CL. Ground contact edges of the tread portion 2 inside and outside the tread portion 2 in the tire width direction are indicated by symbol GEi and symbol GEo respectively.

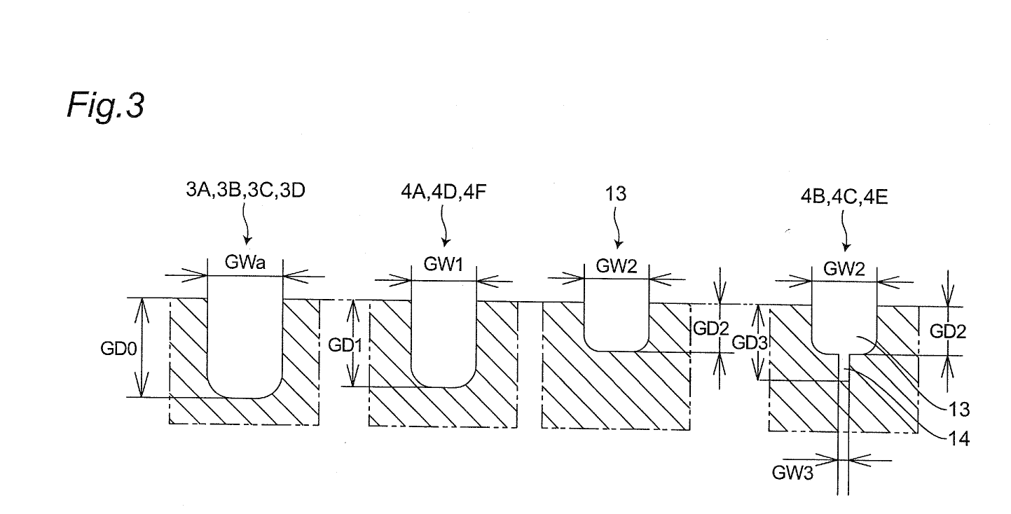

Also referring to FIG. 3, the inner main groove 3A positioned most inside in the tire width direction is a linear groove having a groove depth GD0 and having substantially a fixed groove width GWa. The outer main groove 3D positioned most outside in the tire width direction is a slightly meandering zigzag-shaped groove having a groove depth GD0 and having a groove width GWd. A first center main groove 3B disposed adjacently to an outer side of the inner main groove 3A in the tire width direction is a linear groove having a groove depth GD0 and having substantially a fixed groove width GWb. A second center main groove 3C disposed adjacently to an inner side of the outer main groove 3D in the tire width direction and adjacently to an outer side of the first center main groove 3B in the tire width direction is a linear groove having a groove depth GD0 and having substantially a fixed groove width GWc.

With four main grooves 3A to 3D and the lateral grooves 4A to 4F, five block rows extending in the tire circumferential direction are formed. That is, the inner shoulder row 5A, the inner intermediate row 5B, the center row 5C, the outer intermediate row 5D and the outer shoulder row 5E are formed.

Among the block rows, the inner shoulder row 5A positioned most inside in the tire width direction is positioned inside the inner main groove 3A in the tire width direction. The inner shoulder row 5A expands toward the inside in the tire width direction (a side portion side of the tire 1 not shown in the drawing) beyond the inner ground contact edge GEL The inner shoulder row 5A includes a plurality of inner shoulder blocks 6 defined by the inner main groove 3A and the plurality of lateral grooves 4A (first lateral grooves) formed at intervals in the tire circumferential direction. In other words, the inner shoulder row 5A is formed of the plurality of inner shoulder blocks 6 arranged in a row in the tire circumferential direction. Two sipes 6a extending in the tire width direction are formed on each individual inner shoulder block 6. A zigzag-shaped slit 6b extending in the tire circumferential direction is formed on a most inner portion of each individual inner shoulder block 6 in the tire width direction. Further, three inner longitudinal slits (first slits) 6c, 6d, 6e are formed on each individual inner shoulder block 6 as described in detail later.

Among the block rows, the outer shoulder row 5E positioned most outside in the tire width direction is positioned outside the outer main groove 3D in the tire width direction. The outer shoulder row 5E expands toward the outside in the tire width direction (a side portion side of the tire 1 not shown in the drawing) beyond the outer ground contact edge GEo. The outer shoulder row 5E includes a plurality of outer shoulder blocks 10 defined by the outer main groove 3D and the plurality of lateral grooves 4F (second lateral grooves) formed at intervals in the tire circumferential direction. In other words, the outer shoulder row 5E is formed of the plurality of outer shoulder blocks 10 arranged in a row in the tire circumferential direction. Three sipes 10a extending in the tire width direction are formed on each individual outer shoulder block 10. An outer longitudinal slit (second slit) 10b is formed on each individual outer shoulder block 10 as described in detail later. A pair of lateral grooves 4F disposed adjacently to each other in the tire circumferential direction is connected to each other by short longitudinal grooves 11 in a region further outside the outer ground contact edge GEo.

The inner intermediate row 5B is disposed adjacently to an outer side of the inner shoulder row 5A in the tire width direction, and is positioned between the inner main groove 3A and the first center main groove 3B. The inner intermediate row 5B includes a plurality of inner intermediate blocks 7 defined by the inner main groove 3A, the first center main groove 3B, and a plurality of lateral grooves 4B formed at intervals in the tire circumferential direction. In other words, the inner intermediate row 5B is formed of the plurality of inner intermediate blocks 7 arranged in a row in the tire circumferential direction. A lateral slit 7a which penetrates the individual inner intermediate block 7 in the tire width direction is formed in the vicinity of the center of the inner intermediate block 7 in the tire circumferential direction. Further, on the inner intermediate block 7, two sipes 7b extending in the tire width direction are formed on both sides of the lateral slit 7a respectively.

The outer intermediate row 5D is disposed adjacently to an inner side of the outer shoulder row 5E in the tire width direction, and is positioned between the outer main groove 3D and the second center main groove 3C. The outer intermediate row 5D includes a plurality of outer intermediate blocks 9 defined by the outer main groove 3D, the second center main groove 3C, and a plurality of lateral grooves (third lateral grooves) 4D, 4E formed alternately at intervals in the tire circumferential direction. In other words, the outer intermediate row 5D is formed of the plurality of outer intermediate blocks 9 arranged in a row in the tire circumferential direction. Three sipes 9a extending in the tire width direction are formed on each individual outer intermediate block 9.

The center row 5C is formed on the center line CL. The center row 5C is disposed adjacently to the inner intermediate row 5B and the outer intermediate row 5D, and is positioned between the first center main groove 3B and the second center main groove 3C. The center row 5C includes a plurality of center blocks 8 defined by the first center main groove 3B, the second center main groove 3C, and a plurality of lateral grooves 4C formed at intervals in the tire circumferential direction. In other words, the center row 5C is formed of the plurality of center blocks 8 arranged in a row in the tire circumferential direction. A plurality of sipes 8a extending in the tire width direction are formed on each individual center block 8.

The lateral grooves 4A to 4F are described with reference to FIG. 3. The lateral groove 4A formed on the inner shoulder row 5A, the lateral groove 4D formed on the outer intermediate row 5D and the lateral groove 4F formed on the outer shoulder row 5E are respectively formed of a “deep lateral groove”. On the other hand, the lateral groove 4B formed on the inner intermediate row 5B, the lateral groove 4C formed on the center row 5C, and the lateral groove 4E formed on the outer intermediate row 5D are respectively formed of a “shallow groove with sipes”.

The lateral groove 4A, 4D, 4F which is the “deep lateral groove” has substantially a rectangular cross-sectional shape. A groove depth GD1 of these lateral grooves 4A, 4D, 4F is set 0.85 to 1.0 times inclusive as large as the groove depth DO of the main grooves 3A to 3D (0.85GD0≦GD1≦1.0GD0). The groove width GW1 of these lateral grooves 4A, 4D, 4F is preferably set to a value which falls within a range of from 2.5 mm to 8 mm inclusive.

The lateral grooves 4B, 4C, 4E which are formed of the “shallow groove with sipes” are formed into a shape where sipes 14 are formed on a groove bottom of the shallow groove 13. In this specification, grooves having a groove depth GD2 which is 0.4 to 0.6 times inclusive as large as the groove depth GD0 of the main grooves 3A to 3D are referred to as “shallow grooves” (0.4GD0≦GD2≦0.6GD0). A groove width GW2 of “shallow groove” is preferably equal to or less than the groove width GW1 of “deep lateral groove” (GW2≦GW1). Further, in this specification, “sipe” is referred to as a cut having a narrower width than “main groove”, “deep lateral groove” and “shallow groove”. In general, the width GW3 is set to a value which falls within a range of from 0.8 mm to 1.5 mm inclusive, and the depth is 2 mm or less. It is preferable that the groove depth GD3 of “shallow groove with sipes” be 0.6 to 1.0 times inclusive as large as the groove depth GD0 of the main grooves 3A to 3D (0.6GD3≦GD0≦GD0). The concept of “sipe” also embraces the sipes 6a of the inner shoulder block 6, the sipes 10a of the outer shoulder block 10, the sipes 7b of the inner intermediate block 7, the sipes 9a of the outer intermediate block 9, and the sipes 8a of the center block 8.

In general, “shallow groove with sipes” exhibits strong resistance against falling of the block caused by a reaction from a ground surface compared to the grooves having the same full depth. Accordingly, it is possible to prevent also lowering of rigidity while preventing lowering a snow column shearing force. To acquire a snow performance enhancing effect by adding the sipes 14 to the groove bottom of the shallow groove 13, it is preferable that the depth of the sipes 14 per se be 0.2 mm or more at minimum. On the other hand, when the width GW3 of “sipes” is smaller than 0.8 mm, a snow performance enhancing effect is small, while when the width GW3 exceeds 1.5 mm, rigidity of the tread portion is largely lowered and hence, both cases are not desirable.

As describe previously, the zigzag-shaped slit 6b is formed on the inner shoulder block 6. The inner longitudinal slits 6c, 6d, 6e are formed on the inner shoulder block 6. The outer longitudinal slit 10b is formed on the outer shoulder block 10. The lateral slit 7a is formed on the inner intermediate block 7. In this specification, these “slits” are referred to cuts having a smaller groove depth and a narrower groove width than “main grooves”, “deep lateral grooves” and “shallow grooves” while having a larger groove depth and a wider groove width than “sipes”.

Referring to FIG. 2, in the inner intermediate block 7 which forms the inner intermediate row 5B, a tire circumferential direction length IHc is larger than a tire width direction length IHw. That is, the inner intermediate block 7 has an elongated shape in the tire circumferential direction. It is preferable that, for example, the tire circumferential direction length IHc be set 1.3 to 1.9 times inclusive as large as the tire width direction length IHw (1.3≦IHc/IHw≦1.9). A camber angle is imparted to the tire 1 mounted on a vehicle. There is a tendency that a shape of a ground contact region on a road surface extends in a tire circumferential direction on an inner portion of the tread portion 2 in a tire width direction (particularly, at the time of applying braking). Accordingly, by forming the inner intermediate block 7 into an elongated shape in the tire circumferential direction, drive performance and braking performance on a dry road surface can be enhanced. Further, by forming the inner intermediate block 7 into an elongated shape in the tire circumferential direction, responsiveness to a steering angle when a handle is steered during traveling is enhanced.

Referring to FIG. 2, in the outer intermediate block 9 which forms the outer intermediate row 5D, a tire width direction length OHw is larger than a tire circumferential direction length OHc. That is, the outer intermediate block 9 has an elongated shape in the tire width direction. It is preferable that, for example, the tire width direction length OHw be set 1.1 to 1.5 times inclusive as large as the tire circumferential direction length OHc (1.1≦OHw/OHc≦1.5). By forming the outer intermediate block 9 into an elongated shape in the tire width direction, rigidity of the outer intermediate block 9 against a load in a lateral direction (tire width direction) is increased and hence, turning performance on a dry road surface is enhanced. Further, the outer intermediate block 9 is formed into an elongated shape in the tire width direction and hence, an edge component in a tire width direction is increased in a region outside the tread portion 2 in the tire width direction. As a result, drive performance and braking performance on a snowy road surface are also enhanced.

In this embodiment, the total number Na of the inner shoulder blocks 6 is set larger than the total number Ne of the outer shoulder blocks 10 (Na>Ne). Further, the total number Nb of the inner intermediate blocks 7 is set smaller than the total number Nd of the outer intermediate blocks 9 (Nb<Nd). In this embodiment, the total number Nd of the outer intermediate blocks 9 and the total number Ne of the outer shoulder blocks 10 are set equal to each other (Nd=Ne). In short, in this embodiment, the total numbers of the blocks Na, Nb, Nd, Ne satisfy the following relationship.

Na>Nd=Ne>Nb

The total number Nc of the center blocks 8 is set smaller than the total numbers Na, Nb, Nd, Ne of the blocks in the block rows other than the center row C.

The total number Na of the inner shoulder blocks 6 can be set 1.8 to 2.5 times inclusive as large as the total number Nb of the inner intermediate blocks 7. The total number Nc of the center blocks 8 can be set 1.0 to 1.4 times inclusive as large as the total number Nb of the inner intermediate blocks 7. The total number Nd of the outer intermediate blocks 9 can be set 1.3 to 1.7 times inclusive as large as the total number Nb of the inner intermediate blocks 7. The total number Ne of the outer shoulder blocks 10 can be set 1.3 to 1.7 times inclusive as large as the total number Nb of the inner intermediate blocks 7.

By setting the total number Na of the inner shoulder blocks 6 larger than the total number Ne of the outer shoulder blocks 10, traction generated by a snow column shearing force is increased particularly at an inner side portion of the tread portion 2 in a tire width direction and hence, snow performance is enhanced. Further, setting the total number Na of the inner shoulder blocks 6 larger than the total number Ne of the outer shoulder blocks 10 means that the outer shoulder block 10 is relatively larger than the inner shoulder block 6 in size. Accordingly, rigidity of the outer shoulder block 10 against a load in a lateral direction becomes relatively high compared to rigidity of the inner shoulder block 6 against a load in a lateral direction and hence, turning performance on a dry road surface is enhanced.

By setting the total number Nb of the inner intermediate blocks 7 smaller than the total number Nd of the outer intermediate blocks 9, as described previously, the tire circumferential direction length IHc of the inner intermediate block 7 is set relatively large compared to the tire circumferential direction length OHc of the outer intermediate block. As a result, as described previously, drive performance and braking performance on a dry road surface are enhanced and, at the same time, responsiveness to a steering angle is also enhanced.

Referring to FIG. 2, the tire circumferential direction length CHc of the center block 8 is set larger than any of the tire circumferential direction lengths ISHc, IHc, OHc, OSHc of the inner shoulder block 6, the inner intermediate block 7, the outer intermediate block 9 and the outer shoulder block 10. The center row 5C includes a center portion in a tire width direction in the ground contact region with a road surface and hence, by setting the tire circumferential direction length IHc of the center block 8 large, responsiveness to a steering angle can be further enhanced.

With such technical features, the tire according to this embodiment can enhance drive performance and braking performance and, at the same time, can enhance turning performance.

Each of the inner intermediate blocks 7 which form the inner intermediate row 5B is defined by the lateral grooves 4 which are “shallow grooves with sipes”. From this point of view, it may be also safe to say that the inner intermediate row 5B is not a block row but is substantially a rib row. As described previously, because of an effect of a camber angle, there is a tendency that a shape of a ground contact region with a road surface extends in a tire circumferential direction at an inner portion of the tread portion 2 in the tire width direction (particularly at the time of applying braking). Accordingly, by substantially forming the inner intermediate row 5B into a rib row, braking performance on a dry road surface is enhanced, and responsiveness to a steering angle is enhanced.

Each of the outer intermediate blocks 9 which form the outer intermediate row 5D is defined by alternately forming the lateral groove 4D which is “deep lateral groove” and the lateral groove 4E which is “shallow groove with sipes”. As described previously, with respect to the outer intermediate block 9, the tire width direction length OHw is larger than the tire circumferential direction length OHc. In other words, the outer intermediate row 5D has a large size in the tire width direction. By forming the lateral groove 4D which is “deep lateral groove” on the outer intermediate row 5D having a large size in the tire width direction, traction on a snowy road surface can be increased and hence, drive performance and braking performance on the snowy road surface can be enhanced. A pair of outer intermediate blocks 9 disposed on both sides of the lateral groove 4E which is “shallow groove with sipes” in the tire circumferential direction can be regarded as one large block. Accordingly, rigidity of the outer intermediate row 5D in the longitudinal direction (tire circumferential direction) can be enhanced so that steering stability can be enhanced.

Hereinafter, various other technical features of the tire 1 according to this embodiment are described.

Referring to FIG. 1 and FIG. 2, the groove width GWb of the first center main groove 3B and the groove width GWc of the second center main groove 3C are set larger than the groove width GWa of the inner main groove 3A and the groove width GWd of the outer main groove 3D.

The first center main groove 3B and the second center main groove 3C are positioned at the center of the tread portion 2 in the tire width direction. At the center of the tread portion 2 in the tire width direction, a boundary portion of a ground contact region with a road surface extends in the tire width direction (lateral direction) in both a step-in side and a kick-out side. Therefore, water which intrudes into the ground contact region at the center of the tread portion 2 in the tire width direction has a velocity vector directed in the tire circumferential direction. Accordingly, by setting the groove widths GWb, GWc of the first center main groove 3B and the second center main groove 3C disposed at the center of the tread portion 2 in the tire width direction large, water which intrudes into the ground contact region can be efficiently introduced to the first center main groove 3B and the second center main groove 3C and hence, water can be effectively drained. That is, by setting the groove widths GWb, GWc of the first center main groove 3B and the second center main groove 3C large, drain performance can be enhanced.

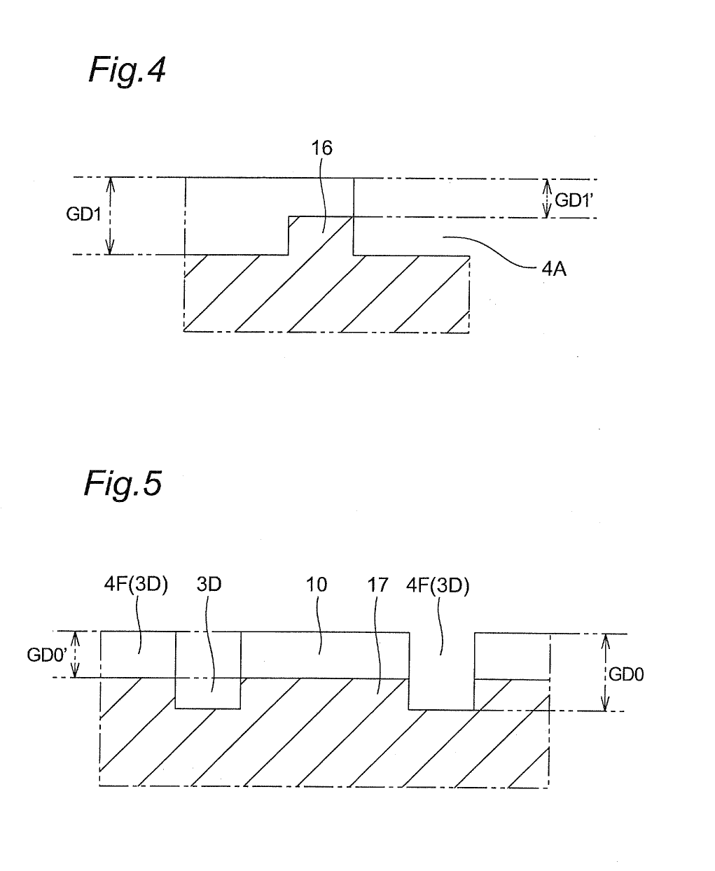

Referring to FIG. 1 and FIG. 2, a first raised portion 16 is formed on every one other of the plurality of lateral grooves 4A disposed on the inner shoulder row 5A. The first raised portion 16 is formed on an inner main groove 3A side of the lateral groove 4A such that a pair of outer shoulder blocks 10A positioned adjacently to both sides of the lateral groove 4A in the tire circumferential direction are connected to each other. A length of the first raised portion 16 in the tire width direction is set sufficiently smaller than a length of the lateral groove 4A in the tire width direction. Also referring to FIG. 4, a top surface of the first raised portion 16 is substantially flat. A groove depth GD1′ of the lateral groove 4A in the first raised portion 16 is set shallower than a groove depth GD1 of the lateral groove 4A (being “deep lateral groove” as described previously) in portions other than the first raised portion 16.

Because of an effect of a camber angle, there is a tendency that a shape of a ground contact region with a road surface extends in a tire circumferential direction at an inner portion of the tread portion 2 in the tire width direction (particularly at the time of applying braking). Accordingly, by connecting the inner shoulder blocks 6 which form the inner shoulder row 5A to each other by the first raised portion 16, the rigidity of the inner shoulder blocks 6 in the longitudinal direction as well as in the lateral direction can be enhanced whereby drive performance and braking performance on a dry road surface can be enhanced.

The first raised portion 16 is formed on a plurality of lateral grooves 4A every one other. Accordingly, in the lateral grooves 4A on which the first raised portion 16 is not formed, the flow of water is not obstructed by the first raised portion 16 and hence, priority is assigned to the ensuring of drain performance. That is, by forming the first raised portion 16 on the plurality of lateral grooves 4A every one other, the tire 1 can acquire both the ensuring of drain performance and the enhancement of drive performance and braking performance on a dry road surface.

It is preferable that the groove depth GD1′ of the lateral groove 4A in the first raised portion 16 be set 0.4 to 0.6 times inclusive as large as the groove depth GD1 of other portions of the lateral groove 4A. When the groove depth GD1′ exceeds 0.6 times of the groove depth GD1, the height of the first raised portion 16 becomes short so that a rigidity enhancing effect in the longitudinal direction brought about by connecting the inner shoulder blocks 6 by the first raised portion 16 cannot be sufficiently acquired. On the other hand, when the groove depth GD1′ becomes lower than 0.4 times of the groove depth GD1, the groove depth of the lateral groove 4A becomes short and hence, drain performance of the lateral groove 4A is remarkably impaired.

Referring to FIG. 1 and FIG. 2, a second raised portion 17 is formed on the outer main groove 3D in a region defined by an imaginary line which connects the outer intermediate block 9 which forms the outer intermediate row 5D and the outer shoulder block 10 which forms the outer shoulder row 5E to each other. An outer side surface of the outer intermediate block 9 in the tire width direction and an inner side surface of the outer intermediate block 10 in the tire width direction are connected to each other by the second raised portion 17. Also referring to FIG. 5, an edge surface of the second raised portion 17 is substantially flat. A groove depth GW0′ of the outer main groove 3D in the second raised portion 17 is set shallower than a groove depth GW0 of the outer main groove 3D in portions other than the second raised portion 17.

One side in the tire width direction of the outer intermediate block 9 which forms the outer intermediate row 5D is defined by the outer main groove 3D. Both sides of the outer intermediate block 9 in the tire circumferential direction are defined by the lateral grooves 4D, 4E. These outer main grooves 3D and lateral grooves 4D, 4E allow the deformation of the outer intermediate blocks 9 in the tire with direction and hence, the outer main grooves 3D and lateral grooves 4D, 4E lowers the rigidity in the lateral direction (tire width direction). However, by connecting the outer intermediate block 9 and the outer shoulder block 10 to each other by the second raised portion 17, it is possible to make these blocks 9, 10 deformed integrally against a load in the lateral direction. That is, with the formation of the second raised portion 17, the rigidity of the outer intermediate block 9 in the lateral direction can be enhanced and hence, steering performance or turning performance on a dray road surface can be enhanced.

The second raised portion 17 is not formed on the entire outer main groove 3D but is partially formed in the region defined by the imaginary line which connects the outer intermediate block 9 and the outer shoulder block 10 to each other. Accordingly, an effect which the second raised portion 17 exerts on the flow of water in the outer main groove 3D is limited and hence, drain performance is ensured.

It is preferable that the groove depth GD0′ of the outer main groove 3D in the second raised portion 17 be set 0.5 to 0.7 times inclusive as large as the groove depth GD0 of other portions of the outer main groove 3D. When the groove depth GD0′ exceeds 0.7 times of the groove depth GD0, the height of the second raised portion 17 becomes short so that a rigidity enhancing effect in the lateral direction brought about by connecting the outer intermediate block 9 to the outer shoulder block 10 by the second raised portion 17 cannot be sufficiently acquired. On the other hand, when the groove depth GD0′ becomes lower than 0.5 times of the groove depth GD0, the groove depth of the outer main groove 3D becomes short and hence, drain performance of the outer main groove 3D is remarkably impaired.

Referring to FIG. 1 and FIG. 2, the lateral groove 4F formed in the outer shoulder row 5E extends toward the outside in the tire width direction beyond the outer ground contact edge GEo in the tire width direction. In a region ranging from the outer intermediate row 5 to the outer shoulder row 5E, that is, in the region from the outer intermediate portion to the further outside of the tread portion 2 in the tire width direction, water which intrudes into the ground contact region with a road surface has a velocity vector inclined toward the outside in the tire width direction with respect to the tire circumferential direction. An inclination angle of the velocity vector is increased toward the outside of the tread portion 2 in the tire width direction. Accordingly, it is possible to effectively drain water by forming the lateral groove 4F which defines the block of the outer shoulder row 5E such that the lateral groove 4F extends beyond the outer ground contact edge GEo in the tire width direction.

The lateral grooves 4D, 4E formed in the outer intermediate row 5D and the lateral groove 4F formed in the outer shoulder row 5E are arranged to be positionally aligned with each other in the tire circumferential direction. Due to this positional alignment, the second center main groove 3C and the outer ground contact edge GEo in the tire width direction are communicated with each other through the lateral grooves 4D, 4E, 4F. When a vehicle turns, an area of a ground contact region with a road surface in a region which includes the outer shoulder row 5E, that is, in an outer region of the tread portion 2 in the tire width direction is increased. Accordingly, to increase drain performance at the time of turning of the vehicle, it is necessary to accelerate the flow of water in the lateral groove 4F toward the outside in the tire width direction. By positionally aligning the lateral grooves 4D, 4E in the outer intermediate row 5 with the lateral groove 4F such that the lateral grooves 4D, 4E communicate with the lateral groove 4F over a range from the second center main groove 3C to the ground contact edge GEo, the flow of water in the lateral groove 4F at the time of turning of the vehicle can be accelerated so that water can be effectively drained.

Referring to FIG. 1 and FIG. 2, as described previously, three inner longitudinal slits 6c to 6e are formed in the inner shoulder block 6 which forms the inner shoulder row 5A. These inner longitudinal slits 6c to 6e are arranged in the tire circumferential direction such that the slits 6c to 6e do not overlap with each other. One ends of the inner longitudinal slits 6c, 6e terminate in the inner shoulder block 6, and the other ends of the inner longitudinal slits 6c, 6e penetrate a side surface of the inner shoulder block 6 in the tire circumferential direction. Both ends of the inner longitudinal slit 6d terminate in the shoulder block 6. The inner longitudinal slits 6c, 6e are set substantially at the same position in the tire width direction. The inner longitudinal slit 6d arranged between the inner longitudinal slits 6c, 6e in the tire circumferential direction is disposed at the position offset toward the inside with respect to the inner longitudinal slits 6c, 6e in the tire width direction. In other words, three inner longitudinal slits 6c to 6e are arranged in a staggered manner in the circumferential direction.

Because of an effect of a camber angle, there is a tendency that a shape of a ground contact region with a road surface extends in a tire circumferential direction at an inner portion of the tread portion in the tire width direction, that is, at a portion where the inner shoulder row 5A is formed (particularly at the time of applying braking). By forming the inner longitudinal slits 6c to 6e arranged in a staggered manner on the inner shoulder block 6, it is possible to disperse the deformation and a ground contact pressure in the inner shoulder block 6 at the time of applying braking. As a result, braking performance on a dray road surface can be enhanced.

Referring to FIG. 1 and FIG. 2, as described previously, one outer longitudinal slit 10b is formed in the outer shoulder block 10 which forms the outer shoulder row 5E. The outer longitudinal slit 10b is formed so as to traverse the outer shoulder block 10 in the tire circumferential direction. That is, both ends of the outer longitudinal slit 10b respectively penetrate side surfaces of the outer shoulder block 10 in the tire circumferential direction.

The outer intermediate block 9 and the outer shoulder block 10 are connected to each other by the second raised portion 17. Accordingly, when the outer intermediate block 9 is deformed against a load in the lateral direction when a vehicle turns, the load in the lateral direction (the deformation in the tire width direction) is transmitted to the outer shoulder block 10 from the outer intermediate block 9. By forming the outer longitudinal slits 10b in the outer shoulder block 10, the load in the lateral direction (the deformation in the tire width direction) transmitted to the outer shoulder block 10 from the outer intermediate block 9 when a vehicle turns can be alleviated. As a result, turning performance on a dry road surface can be enhanced.

With the above-mentioned technical features, the tire 1 according to this embodiment can enhance drive performance, braking performance and turning performance while ensuring drain performance.

As described previously, in the outer intermediate row 5D, the lateral groove 4D which forms “deep lateral groove” and the lateral groove 4E which forms “shallow groove with sipes” are alternately formed. Compared to the pair of outer intermediate blocks 9 positioned on both sides of the lateral groove 4D which forms “deep lateral groove”, the pair of outer intermediate blocks 9 positioned on both sides of the lateral groove 4E which forms “shallow groove with sipes” in the tire circumferential direction are relatively strongly connected to each other. In other words, there is a tendency that the pair of outer intermediate blocks 9 positioned on both sides of the lateral groove 4E in the tire circumferential direction is integrally deformed against a load in a longitudinal direction and a load in a lateral direction. Further, as described previously, by connecting the outer intermediate block 9 and the outer shoulder block 10 to each other using the second raised portion 17, these blocks 9 and 10 are integrally deformed against a load in a lateral direction. Due to such a structure, as indicated by symbol U in FIG. 1, it can be supposed that the pair of outer intermediate blocks 9 positioned on both sides of the lateral groove 4E which forms “shallow groove with sipes” in the tire circumferential direction and the pair of outer shoulder blocks 10 connected with these pair of outer intermediate blocks 9 using the second raised portion 17 form one unit. There is a tendency that this unit U is integrally deformed against a load in a longitudinal direction and a load in a lateral direction due to the lateral groove 4E which is “shallow groove with sipes” and the second raised portion 17. Since the unit U is provided on an outer portion of the tread portion 2 in the tire width direction, particularly, turning performance on a dry road surface is enhanced.

(Evaluation Test)

With respect to the comparative examples 1 to 6 shown in the following Table 1 and the examples 1 to 4 shown in the following Table 2, evaluation tests were carried out on drive performance (dry drive performance), braking performance (dry braking performance) and turning performance (dry turning performance) on a dry road surface. Data which are not specifically referred to below are data shared in common among the comparative examples 1 to 6 and the examples 1 to 4. Particularly, in all comparative examples 1 to 6 and examples 1 to 4, the evaluation was made on conditions where a size of the tire is 225/50R17 and the tire is mounted on an FF sedan of 2000 cc.

TABLE 1

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Remarks | IHc/IHw | IHc/IHw | OHw/OHc | OHw/OHc | Magnitude | Magnitude |
| | smaller than | larger than | smaller than | larger than | relationship | relationship |
| | the lower | the upper | the lower | the upper | between the | between the |
| | limit value | limit value | limit value | limit value | numbers Na | numbers Nb |
| | | | | | and Ne of | and Nd of |
| | | | | | blocks reversed | blocks reversed |
| IHc/IHw | 1.1 | 2.1 | 1.6 | 1.6 | 1.6 | 1.6 |
| OHw/OHc | 1.3 | 1.3 | 0.9 | 1.7 | 1.3 | 1.3 |
| Number of | Na > Nd = | Na > Nd = | Na > Nd = | Na > Nd = | Na > Nd = | Na > Nd = |
| blocks | Ne > Nb | Ne > Nb | Ne > Nb | Ne > Nb | Ne > Nb | Ne > Nb |
| Drive | 100 | 100 | 101 | 101 | 100 | 99 |
| performance | | | | | | |
| Braking | 100 | 100 | 101 | 101 | 101 | 99 |
| performance | | | | | | |
| Turning | 100 | 100 | 98 | 99 | 98 | 101 |
| performance | | | | | | |

TABLE 2

| | Example 1 | Example 2 | Example 3 | Example 4 |
|---|---|---|---|---|
| Remarks | IHc/IHw set | IHc/IHw set | OHw/OHc set | OHw/OHc |
| | to the lower | to the upper | to the lower | set to the |
| | limit value | limit value | limit value | upper limit |
| | | | | value |
| IHc/IHw | 1.3 | 1.9 | 1.6 | 1.6 |
| OHw/OHc | 1.3 | 1.3 | 1.1 | 1.5 |
| Number of | Na > Nd = | Na > Nd = | Na > Nd = | Na > Nd = |
| blocks | Ne > Nb | Ne > Nb | Ne > Nb | Ne > Nb |
| Drive | 102 | 104 | 103 | 103 |
| performance | | | | |
| Braking | 102 | 104 | 103 | 103 |
| performance | | | | |
| Turning | 102 | 103 | 101 | 104 |
| performance | | | | |

With respect to drive performance, each tire was mounted on a vehicle, and a time necessary for acceleration from stopped state to 60 km/h on a dry road surface was measured. The evaluation was made by expressing a result of a comparative example 1 as an index of 100. In Tables 1 and 2, the larger the index, the more excellent drive performance the tire has.

With respect to braking performance, each tire was mounted on a vehicle, and a braking distance required for stopping a vehicle after starting ABS braking at 100 km/h on a dry road surface was measured. The evaluation was made by expressing a result of a comparative example 1 as an index of 100. In Tables 1 and 2, the larger the index, the more excellent braking performance the tire has.

With respect to turning performance, each tire was mounted on a vehicle, and the vehicle traveled while turning in a regular circle having a radius R20 on a dry road surface under a condition where one person was in the vehicle. The lap time was evaluated by an index. The evaluation was made by expressing a result of a comparative example 1 as an index of 100. In Tables 1 and 2, the larger the index, the more excellent dry braking performance the tire has.

In all examples 1 to 4, the index of drive performance was 102 or more and hence, the tire had favorable dry drive performance. In all examples, the index of braking performance was 102 or more and hence, the tire had favorable dry braking performance. Further, in all examples, the index of turning performance was 101 or more and hence, the tire had favorable dry turning performance.

In the comparative examples 1 and 2 where the rate IHc/IHw falls outside the previously-mentioned favorable range (1.3≦IHc/IHw≦1.9), the index of any one of drive performance, braking performance and turning performance was 100. That is, in the comparative examples 1 and 2, the tires could not acquire favorable performance with respect to all evaluated performances. Next, in the comparative examples 3 and 4 where the rate OHw/OHc falls outside the previously-mentioned favorable range (1.1≦OHw/OHc≦1.5), the index of turning performance was 98. That is, in the comparative examples 3 and 4, the tires exhibited particularly poor turning performance. In the comparative example 5 where the total number Ne of the outer shoulder blocks 10 is larger than the total number Na of the inner shoulder blocks 6, although the index of braking performance was 101, the index of turning performance was 98. Accordingly, the tire could not acquire favorable turning performance. In the comparative example 6 where the total number Nb of the inner intermediate blocks 7 is larger than the total number Nd of the outer intermediate blocks 9, although the index of turning performance was 101, both the index of drive performance and the index of braking performance were 100. That is, in the comparative example 6, the tire could not acquire favorable drive performance and braking performance.

As has been described heretofore, from the comparison between the comparative examples 1 to 6 and the examples 1 to 4, it is understood that, according to the pneumatic tire of the present invention, drive performance and braking performance can be enhanced and, at the same time, turning performance can be also enhanced.

What is claimed is:

1. A pneumatic tire comprising:
at least three main grooves formed on a tread portion such that the three main grooves extend in a tire circumferential direction;
a plurality of lateral grooves formed on the tread portion; and
at least four block rows each of which includes a plurality of blocks defined respectively by the main grooves and the pair of lateral grooves disposed adjacently to each other and arranged in a row in a tire circumferential direction,
wherein the block row includes:
an inner shoulder row positioned most inside in a tire width direction in a state where the pneumatic tire is mounted on a vehicle;
an outer shoulder row positioned most outside in the tire width direction in a state where the pneumatic tire is mounted on the vehicle;
an inner intermediate row disposed adjacently to the outside of the inner shoulder row in the tire width direction; and
an outer intermediate row disposed adjacently to the inside of the outer shoulder row in the tire width direction, and
wherein, in the block belonging to the inner intermediate row, a tire circumferential direction length is larger than a tire width direction length, and
wherein, in the block belonging to the outer intermediate row, a tire width direction length is larger than a tire circumferential direction length.

2. The pneumatic tire according to claim 1, wherein in the block belonging to the inner intermediate row, the tire circumferential direction length is 1.3 to 1.9 times inclusive as large as the tire width direction length.

3. The pneumatic tire according to claim 1, wherein in the block belonging to the outer intermediate row, the tire width direction length is 1.1 to 1.5 times inclusive as large as the tire circumferential direction length.

4. The pneumatic tire according to claim 2, wherein in the block belonging to the outer intermediate row, the tire width direction length is 1.1 to 1.5 times inclusive as large as the tire circumferential direction length.

5. The pneumatic tire according to claim 1, wherein a total number of blocks belonging to the inner shoulder row is larger than a total number of blocks belonging to the outer shoulder row, and
wherein a total number of the blocks belonging to the inner intermediate row is smaller than a total number of blocks belonging to the outer intermediate row.

6. The pneumatic tire according to claim 1, wherein the block row further includes a center row positioned on a center side of the tread portion in the tire width direction with respect to the inner intermediate row and the outer intermediate row, and
wherein a tire circumferential direction length of the block belonging to the center row is larger than a tire circumferential direction length of the block belonging to any one of the inner shoulder row, the inner intermediate row, the outer intermediate row and the outer shoulder row.
